(19) United States
(12) Patent Application Publication
(10) Pub. No.: US 2014/0111548 A1
(43) Pub. Date: Apr. 24, 2014

(54) SCREEN DISPLAY CONTROL METHOD OF TERMINAL

(71) Applicant: SAMSUNG ELECTRONICS CO., LTD., Gyeonggi-do (KR)

(72) Inventor: Hokuen SHIN, Gyeonggi-do (KR)

(73) Assignee: SAMSUNG ELECTRONICS CO., LTD., Gyeonggi-do (KR)

(21) Appl. No.: 13/778,637

(22) Filed: Feb. 27, 2013

(30) Foreign Application Priority Data
Oct. 22, 2012 (KR) 10-2012-0117132

(51) Int. Cl. G09G 5/32

(52) U.S. Cl. CPC G09G 5/32
USPC 345/650

(57) ABSTRACT

A method and apparatus for controlling display mode switching based on the rotation pattern of a portable terminal prevents unwanted orientation changes in the display for certain movements. The display mode switching control method of the present invention includes extracting a rotation pattern including pitch, roll, and yaw angles of the terminal; determining whether the rotation pattern is a valid rotation pattern based on the angles; and switching, when the rotation pattern is the valid rotation pattern, from a current display mode to other display mode.

### CLAIM OF PRIORITY

This application claims the benefit under 35 U.S.C. §119(a) from a Korean patent application filed on Oct. 22, 2012 in the Korean Intellectual Property Office and assigned Serial No. 10-2012-0117132, the entire disclosure of which is hereby incorporated by reference in its entirety.

### BACKGROUND OF THE INVENTION

1. Field of the Invention

The present invention relates to a screen display control method and apparatus of a terminal. More particularly, the present invention relates to a method and apparatus for controlling display mode switching based on the rotation pattern of the terminal.

2. Description of the Related Art

With the integration of wireless Internet access function as a basic element, the portable terminals can be used for various purposes such as web surfing, Social Networking Service (SNS), and reading electronic books (e-books). As the purposes for usage is diversified, the portable terminal is used anywhere, indoors or outdoors, and in various postures, e.g. leaning on a wall or lying on the back.

The conventional terminal detects the change of its orientation from the view point of the direction of the gravity so as to switch between screen display modes based on an assumption that the user would want the orientation of the screen to correspond to the detected change in orientation. However, such a conventional terminal has a drawback in that the screen display mode is changed unwantedly as the user changes the posture, e.g. lies down or tilts the terminal in a certain direction.

As shown in an exemplary case of FIG. 1, in the case where the user holding a terminal having a relatively large display in the left hand tries to make an input by touching a key 10 at the right side of the on the screen with the left hand, it tends to tilt the terminal to the left. At this time, if the terminal is tilted beyond a predetermined angle, an unintended display mode switching occurs such that the key 10 changes in position, resulting in manipulation inconvenience.

Furthermore, as shown in another exemplary case of FIG. 2, in the case where the user lies down on a bed or couch, watching a video with the terminal in the landscape mode, rolls over to the side, the display mode of the terminal is switched to the portrait mode although the viewing direction is not changed, resulting in user inconvenience.

### SUMMARY OF THE INVENTION

The present invention has been made in an effort to solve at least some of the above problems and provide some of the advantages to be described herein below. It is an object of the present invention to provide a display mode switching control method and apparatus for a terminal that can switch between display modes according to the rotation pattern of the terminal orientation.

It is another of the various objects of the present invention to provide a display mode switching control method and apparatus of a terminal for maintaining the current display mode when just one of a roll and a pitch rotations is detected by a gyro sensor.

In accordance with an exemplary aspect of the present invention, a display mode switching control method of a terminal includes extracting a rotation pattern including pitch, roll, and yaw angles of the terminal; determining whether the rotation pattern is a valid rotation pattern based on the angles; switching, when the rotation pattern is determined to be a valid rotation pattern.

Preferably, the extracting a rotation pattern operation includes checking whether an automatic display mode switching function is enabled; and extracting, when the automatic display mode switching function is enabled, the rotation pattern.

Preferably, the extracting operation includes checking the rotation pattern at a predetermined period.

Preferably, the determining operation includes comparing each of the angles with a predetermined threshold angle; and judging, when all of the angles are in a threshold angle range defined by the threshold angle, that the rotation pattern is the valid rotation pattern.

Preferably, the determining operation also includes determining whether the yaw angle is in a predetermined threshold angle range; and judging, when the yaw angle is in the threshold angle range, that the rotation pattern is the valid rotation pattern.

Preferably, the switching operation includes determining a target display mode based on the rotation pattern; and switching, when the target display mode differs from the current display mode, from the current display mode to the target display mode.

In accordance with another exemplary aspect of the present invention, a terminal includes a sensing unit which extracts a rotation pattern including a pitch, a roll, and a yaw angles; a display unit which displays a screen; and a control unit which determines whether the rotation pattern is a valid rotation pattern based on the angles and controls, when the rotation pattern is the valid rotation pattern, the display unit to switch from a current display mode to other display mode.

Preferably, the control unit is configured to check whether or not an automatic display mode switching function is enabled and controls, when the automatic display mode switching function is enabled, the sensing unit so as to extract the rotation pattern.

Preferably, the sensing unit senses the rotation pattern during a predetermined period.

Preferably, the control unit is further configured to compare each of the angles with a predetermined threshold angle and determines (judges) that the rotation pattern is the valid rotation pattern, when all of the angles are in a threshold angle range defined by the threshold angle.

Preferably, the control unit is configured to determine whether the yaw angle is in a predetermined threshold angle range and determines that the rotation pattern is the valid rotation pattern, when the yaw angle is in the threshold angle range.

Preferably, the control unit also determines a target display mode based on the rotation pattern and switches, when the target display mode differs from the current display mode, from the current display mode to the target display mode.

### BRIEF DESCRIPTION OF THE DRAWINGS

FIG. 1 is a diagram illustrating an exemplary display mode switching situation of a conventional terminal;

FIG. 2 is a diagram illustrating another exemplary display mode switching situation of the conventional terminal;

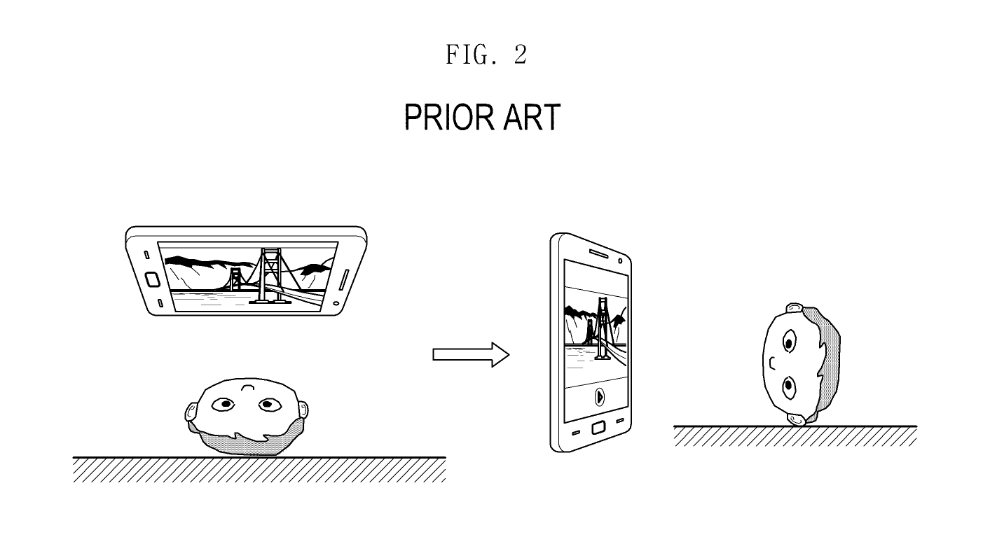

FIG. 3 is a block diagram illustrating a configuration of the terminal according to an exemplary embodiment of the present invention;

FIG. 4 is a flowchart illustrating a display mode switching method of the terminal according to an exemplary embodiment of the present invention;

FIG. 5 is a diagram illustrating 3-dimensional rotation axes for use in the display mode switching method according to an exemplary embodiment of the present invention;

FIG. 6 is a diagram illustrating an exemplary x axis rotation for use in the display mode switching method according to an exemplary embodiment of the present invention;

FIG. 7 is a diagram illustrating an exemplary y axis rotation for use in the display mode switching method according to an exemplary embodiment of the present invention;

FIG. 8 is a diagram illustrating an exemplary z axis rotation for use in the display mode switching method according to an exemplary embodiment of the present invention;

FIG. 9 is a diagram illustrating a rotation pattern table for use in the display mode switching method according to an exemplary embodiment of the present invention; and

FIG. 10 is a flowchart illustrating a rotation pattern validity determination procedure of the display mode switching method according to an exemplary embodiment of the present invention.

### DETAILED DESCRIPTION

The present invention is applicable, inter alia, for switching between the screen display modes of a terminal.

Also, the present invention is applicable to all of the different types of devices supporting the display mode switching function, the devices including smartphone, portable terminal, mobile terminal, Personal Digital Assistant (PDA), Portable Multimedia Player (PMP), laptop computer, notepad, Wibro terminal, Tablet PC, smart TV, smart refrigerator, etc.

In the following description, the term “screen display mode” may denote the vertical orientation of the screen on the display panel. In an exemplary case of the terminal equipped with a display panel of 3:4 aspect ratio, if the top and bottom sides of the screen match 3, this is referred to as “portrait mode.” Otherwise, if the top and bottom sides of the screen match 4, this is referred to as “landscape” mode.” Here, the landscape mode also can be referred to as a full screen or full screen mode.

In the following description, the terms “pitch,” “roll,” and “yaw” may denote the values of angles rotated around the x, y, and z axes, respectively. At this time, the origin where the x, y, and z axes cross corresponds to the center of the cube formed around the terminal. The x and y axes cross at the origin to form a plane horizontal with the surface of the display panel. The z axis passes the origin to penetrate the center of the surface of the display panel. The pitch, roll, and yaw angles are represented by Θ, φ, and ψ herein.

The terminology used herein is for the purpose of describing particular exemplary embodiments only and is not intended to be limiting of the invention (illustrative purposes and not for limitation). Unless otherwise defined, all terms used herein have the same meaning as commonly understood by one of ordinary skill in the art to which this invention pertains, and should not be interpreted as having an excessively comprehensive meaning, nor as having an excessively contracted meaning. If technical terms used herein is erroneous that fails to accurately express the technical idea of the present invention, it should be replaced with technical terms that allow the person in the art to properly understand. The general terms used herein should be interpreted according to the context used and should not be interpreted as an excessively contracted meaning.

The singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof.

Exemplary embodiments of the present invention are described herein below with reference to the accompanying drawings in detail.

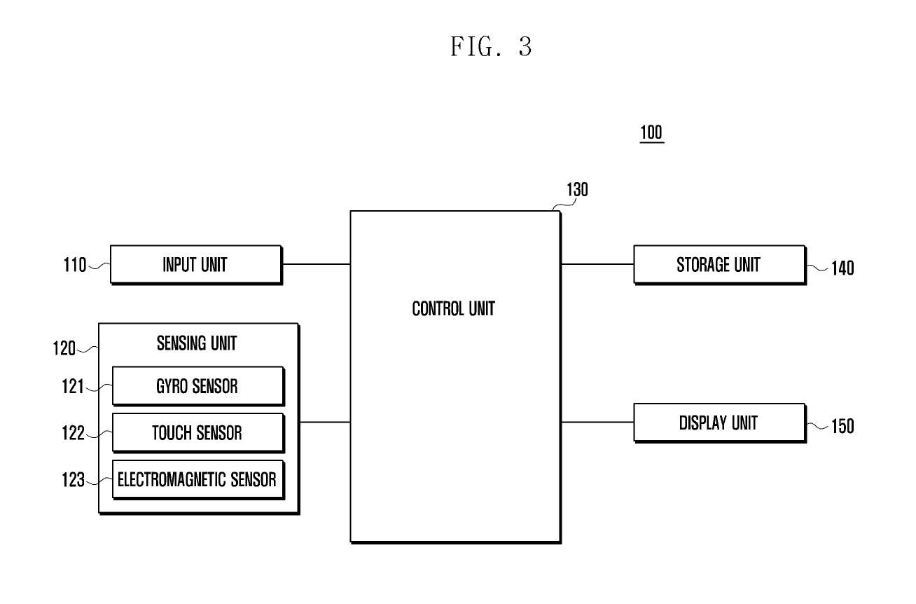

FIG. 3 is a block diagram illustrating a configuration of the terminal according to an exemplary embodiment of the present invention.

Referring now to FIG. 3, the terminal 100 preferably includes an input unit 110, a sensing unit 120, a control unit 130, a storage unit 140, and a display unit 150.

The input unit 110 can generate a manipulation single corresponding to a user input. The input unit 110 may include at least one of a keypad, a dome switch, a jog wheel, and a jog switch. The input unit 110 can be implemented with at least one of a touch sensor, a pressure sensor, a proximity sensor, electromagnetic sensor in the form of a pad such as touchpad (capacitive/resistive), Electro Magnetic Resonance (EMR) pad, Electro Magnetic Interference (EMI) pad. The input unit 110 can detect a user input made by various input means such as human body (e.g. hand), stylus pen, and other physical object. The input unit 110 may also include a plurality of layered pads.

The input unit 100 also can be implemented in the form of a screen layered with the display unit 150. For example, the input unit 110 can be implemented in the form of a Touch Screen Panel (TSP) including an input pad with a touch sensor and combined with the display unit 150.

According to an exemplary embodiment of the present invention, the input unit 110 receives an input for configuring the automatic screen display mode switching function.

The sensing unit 120 may include a gyro sensor 121, and/or a touch sensor 122, and/or an electromagnetic sensor 123.

The gyro sensor 121 measures the rotation angle of the terminal 100 and detects the angle rotated on the 3-dimensional reference axis. For example, the gyro sensor 121 can sense the rotation angles on the x, y, and z axes having the center of the terminal as the origin, i.e. pitch, roll, and yaw.

The touch sensor 122 preferably detects a touch input made by the user. For example, the touch sensor 122 detects the touch input and generates the corresponding touch signal to the control unit 130. A used herein, the terms “touchscreen” and “touch sensor” do not require express contact, for example, a body part or parts such as a finger, or a stylus if arranged within a certain predetermined distance of the touch screen, so as to be sensed by the sensor or touch screen of the mobile terminal and is considered a touch for the purposes of this claimed invention and generates a touch signal although a literal touch of the touch screen, for example, has not occurred. In any event, the control unit 130 analyzes the touch signal and performs an operation according to the analysis result. The control unit 130, which comprises hardware such as a processor or microprocessor that is configured for operation may also control the display unit 150 to display the information corresponding to the touch signal. The touch sensor 122 can be combined with the input unit 110 to receive the manipulation signal corresponding to the user's touch input through various input means. Depending on the specific implementation, the touch sensor 122 can detect a proximity input within a predetermined range as well as the touch input.

With continued reference to FIG. 3, the electromagnetic sensor 123 detects a touch or proximity input according to the variation of the electromagnetic field in strength. The electromagnetic sensor 123 may include an electromagnetic field induction coil to detect the approach of an object including a resonance circuit causing energy variation in the magnetic field generated by the electromagnetic sensor 123. The object, including the resonance circuit, may comprise a stylus pen. The electromagnetic sensor 123 can detect the proximity input or hovering within a predetermined distance from the terminal 100 as well as direct touch input.

According to an exemplary embodiment of the present invention, the sensing unit 120 can function by extracting the rotation pattern including a rotation angle on each rotation axis. The sensing unit 120 also may extract the rotation pattern during a predetermined period.

The control unit 130 is us configured for controlling the components for the operation of the terminal. For example, the control unit 130 controls the display unit 150 to switch between the screen display modes.

According to an exemplary embodiment of the present invention, the control unit 130 determines whether the rotation pattern extracted by the sensing unit 120 is a valid rotation pattern. If the rotation pattern is the valid one, the control unit 130 controls the display unit 150 to switch to the corresponding display mode.

According to an exemplary embodiment of the present invention, the control unit 130 checks the automatic display mode switching configuration and, if the automatic display mode switching is enabled, determines whether or not the rotation pattern is a valid rotation pattern. Particularly in an exemplary embodiment of the present invention, the control unit 130 determining whether the rotation pattern is valid to require display mode switching based on the yaw angle as well as the pitch and roll angles.

A description will now be made of the detailed operations of the control unit 130 hereinafter with reference to accompanying drawings.

The storage unit 140 stores the programs or commands for the operation of the terminal 100. The control unit 130 can execute the programs or commands stored in the storage unit 140.

The storage unit 140, which comprises a non-transitory medium, includes at least one of the flash memory type, hard disk type memory, multimedia card micro type memory, card type memory (e.g. SD or XD memory), Random Access Memory (RAM), Static RAM (SRAM), Read-Only Memory (ROM), Electrically Erasable Programmable Read-Only Memory (EEPROM), Programmable Read-Only Memory (PROM), magnetic memory, magnetic disk, and optical disk.

According to an exemplary embodiment of the present invention, the storage unit 140 stores the extracted rotation pattern temporarily or semi-persistently. The storage unit 140 also stores the “n” rotation patterns extracted at a predetermined period, temporarily or semi-persistently.

The display unit 150 displays (outputs) the information processed in the terminal 100. For example, the display unit 150 is displays the User Interface (UI) or Graphic User Interface (GUI) related to the voice recognition, situation recognition, and function control.

The display unit 150 can implement at least one of a Liquid Crystal Display (LCD), Thin Film Transistor-Liquid Crystal Display (TFT LCD), Organic Light-Emitting Diode (OLED), flexible display, and 3-Dimentional (3D) display, just to name some non-limiting examples.

The display unit 150 can be layered with the touch sensor 122 included in the input unit 110 so as to operate as a touchscreen. At this time, the touchscreen-enabled display unit 150 can function as an input device.

According to an exemplary embodiment of the present invention, the display unit 150 may operate in a certain display mode.

Although FIG. 3 is directed to an exemplary configuration, the terminal 100 can be configured with additional components or without some of the depicted components. No limitation of the claimed invention should be inferred in this regard.

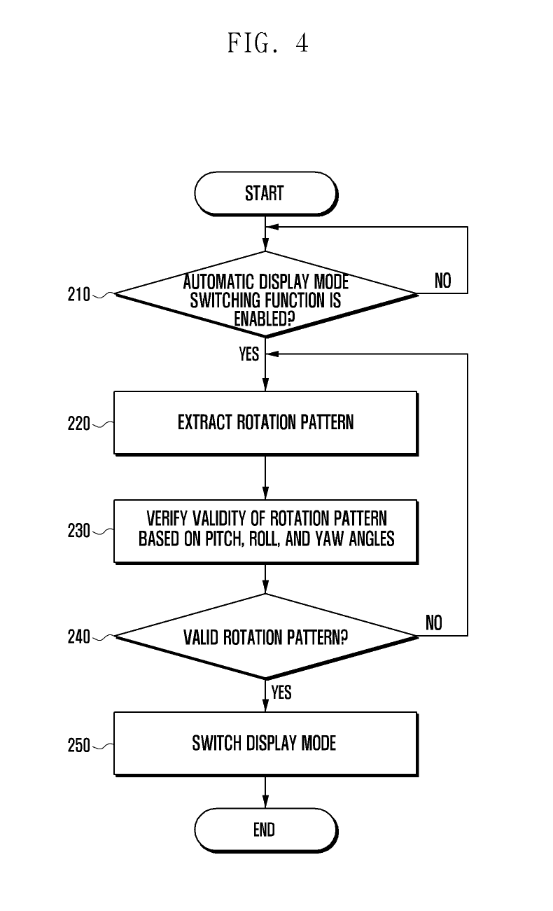

FIG. 4 is a flowchart illustrating a display mode switching control method of the terminal according to an exemplary embodiment of the present invention.

Referring now to FIG. 4, the display mode switching control method according to an exemplary embodiment of the present invention can include the following steps.

At S210, the control unit 130 first determines whether or not the automatic display mode switching is enabled.

The control unit 130 checks the automatic display mode switching configuration status. The automatic display mode switching configuration status can be the status configured by the user or designated as default value. If the automatic display mode switching function is enabled, the control unit 130 can control the display unit 150 to switch between the display modes automatically according to the rotation pattern of the terminal 100. Otherwise, if the automatic display mode switching function is disabled, the control unit 130 can control the display unit 150 to operate in a fixed display mode. Here, the fixed displayed mode can be the one set by the user or designated as default.

The control unit 130 can control the display unit 150 to display a UI or GUI for the automatic display mode switching status configuration in response to a request or according to necessity. The control unit 130 can receive the configuration input by the user and store the configuration status.

The control unit 130 determines whether the automatic display mode switching configuration status set as described above is the enabled status or disabled status.

At S220, if the automatic display mode switching function is enabled, the control unit 130 extracts the rotation pattern.

The control unit 130 extracts the rotation pattern including the rotation angles on the respective rotation axes. More particularly, the control unit 130 can extract the rotation angles according to the rotation status of the terminal 100 on x, y, and z axes crossing the center of the terminal 100 as the origin. Here, the rotation patterns on x, y, and z axes are referred to as pitch, roll, and yaw. The rotation angles of pitch, roll, and yaw can be expressed by Θ, φ, and ψ. The control unit 130 of terminal 100 extracts the rotation angles as values or coordinates. The control unit 130 also can extract the rotation angles in the range of −180° ˜+180° or 0° ˜360°.

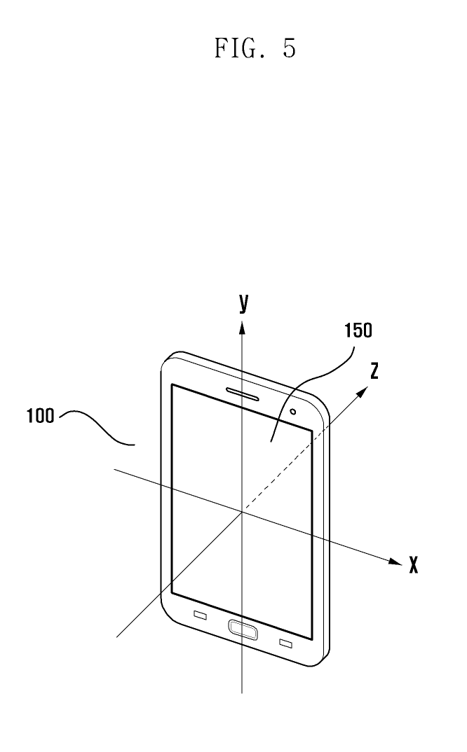

Referring now to FIG. 5, the origin where all axes cross can correspond to the center of a cube forming the body of the terminal 100. The x axis can be the horizontal axis in association with the body of the terminal 100. The y axis can be the vertical axis in association with the body of the terminal 100. The x and y axes forms a plane parallel to the surface of the display unit 150 of the terminal 100. The z axis is the axis vertical to this plane and penetrating the surface of the display unit 150 at its center. The control unit 130 can detect the rotation angles on the x, y, and z axes as shown in FIG. 5.

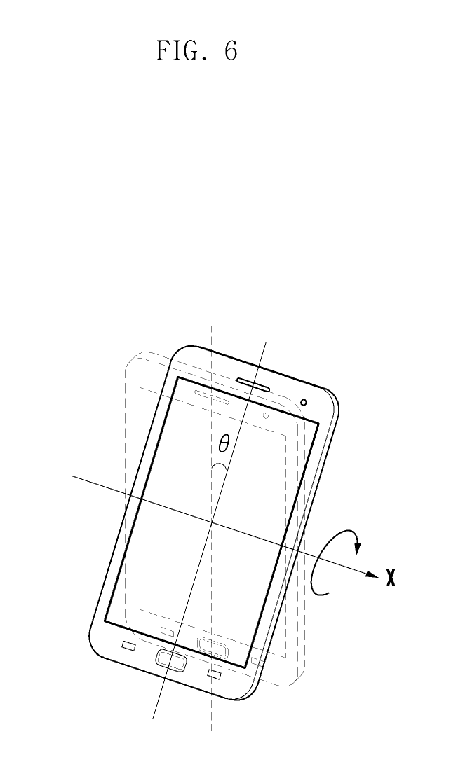

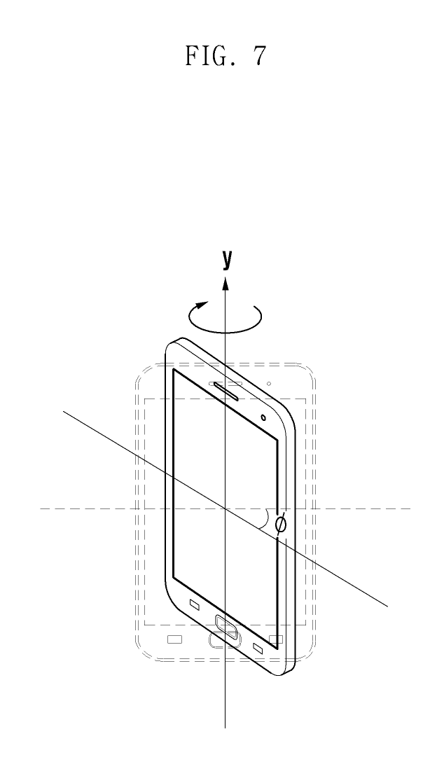

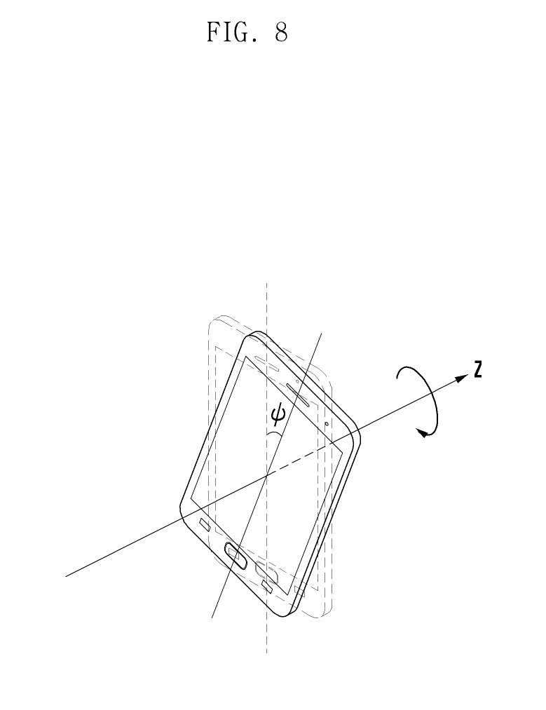

As shown in FIG. 6, the control unit 130 detects the pitch angle Θ as rotation angle of the terminal on the x axis. As shown in FIG. 7, the control unit 130 is capable of detecting the roll angle φ as rotation angle of the terminal on the y axis. Also, as shown in FIG. 8, the control unit 130 is capable of detecting the yaw angle ψ as rotation angle of the terminal on the z axis.

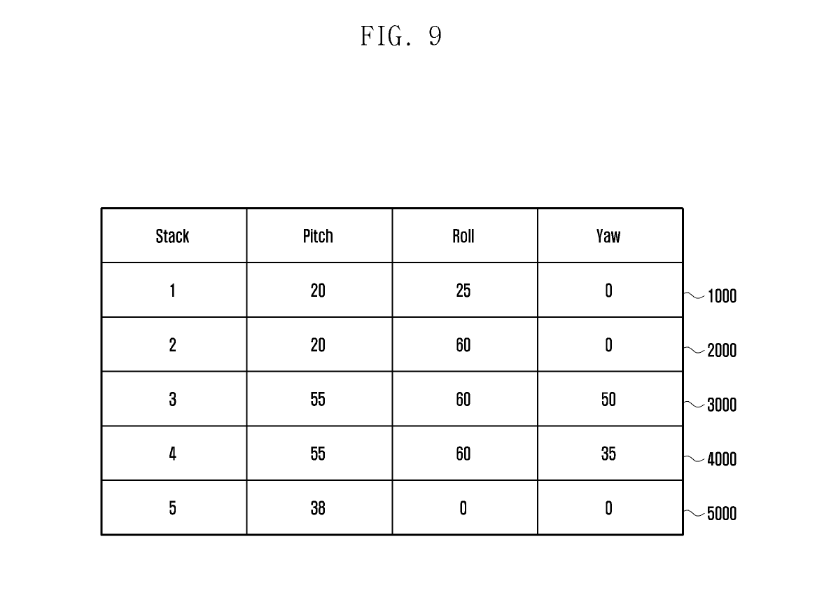

The control unit 130 extracts the rotation pattern at a predetermined period. The control unit 130 may also store the extracted rotation pattern temporarily or semi-persistently. For example, the control unit 130 can extract the rotation pattern at predetermined period and store “n” data in the form of a stack in a buffer temporarily or semi-persistently, as shown in FIG. 9. If the number of extracted rotation patterns is greater than n (in this particular non-limiting example there are 5 extracted rotation patterns), the control unit 130 updates the data by deleting the oldest rotation pattern and adding the newly extracted rotation pattern in the buffer.

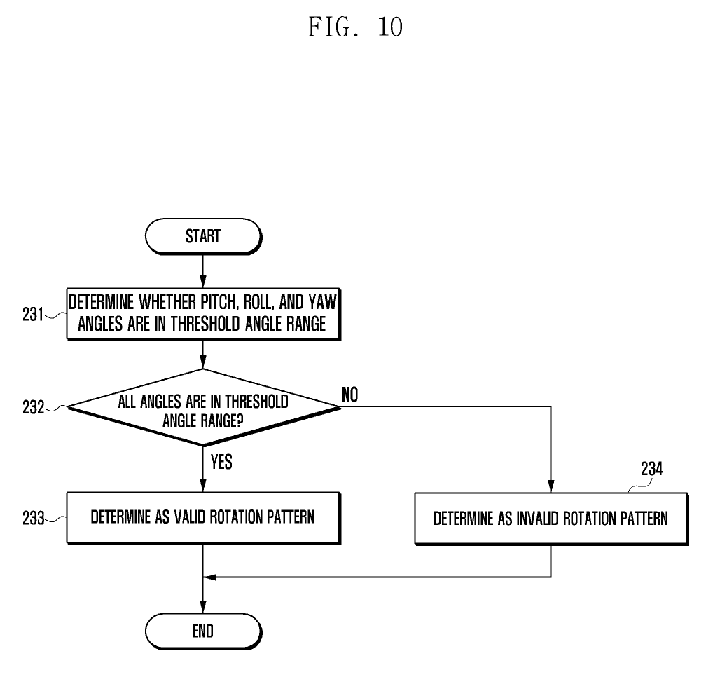

Next, with reference to the flowchart in FIG. 4, at S230, the control unit 130 determines whether the rotation pattern constitutes a valid pattern. FIG. 10 illustrates the operations that can be performed at S230.

Referring now to FIG. 10, at S231 the control unit 130 determines whether each of the pitch, roll, and yaw angles is in a predetermined threshold range. In other words, the control unit 130 compares each rotation angle to a predetermined threshold angle in order to determine whether the rotation angle is in the threshold angle range.

The threshold angle can be the angle for determining whether to perform the display mode switching. If the pitch, roll, and yaw are in the threshold angle range, the control unit 130 determines to perform the display mode switching of the display unit 150. The threshold angle can be preconfigured for each rotation axis or rotation pattern, and the minimum and/or maximum angle value or angle range can be configured.

Referring now to FIG. 9, the control unit 130 can extract the rotation pattern at a predetermined period. The terminal 100 extracts the rotation pattern at the predetermined period and determines whether the rotation angle of each rotation pattern is in the range of the threshold angle range. For example, when the threshold angle is configured to be over 45°, the rotation pattern 1000 of stack 1 is less than the threshold for all rotation axes so as to be out of the range of the threshold angle range. Meanwhile, the rotation pattern 2000 of stack 2 has the roll angle greater than the threshold angle such that the control unit 130 determines that the roll angle is in the threshold angle range while the pitch and yaw angles are out of the threshold angle range. However, the rotation pattern 4000 at stack 3 has all of the pitch, roll and yaw angles in the threshold angle range, as discussed herein below.

As shown in FIG. 9, the control unit 130 can be configured to extract the rotation pattern repeatedly according to the predetermined period. The control unit 130 also determines repeatedly whether the rotation angles of the rotation pattern are in the range of the threshold angle range.

In another exemplary embodiment of the present invention, the control unit 130 determines whether the pitch, roll, and yaw angles are all in the threshold angle range and, if all of the pitch, roll, and yaw angles are out of the threshold angle range, extracting the rotation pattern at the predetermined period again. For example, in the rotation pattern 2000 of stack 2 of FIG. 9, not all of the rotation angles are in the threshold angle range such that the control unit 130 extracts the rotation pattern again. The rotation pattern 300 of stack 3 which is extracted afterward has the rotation angles all are in the threshold angle range over 45° and thus the control unit 130 performing the next step.

Next, at S232 the control unit 130 determines whether the pitch, roll, and yaw angles are all in the threshold angle range.

For example, if the pitch, roll, and yaw angles are all greater than 45° as the rotation pattern 300 of stack 3 of FIG. 9, the control unit 130 determines that all rotation angles are in the threshold angle range.

If at S232 all of the rotation angles are in the threshold angle range, then at S233 the control unit 130 determines that the current rotation pattern is a valid rotation pattern.

Otherwise, if not all of the rotation angles are in the threshold angle range, then at S234 the control unit 130 determines that the current rotation pattern is invalid.

For example, the rotation pattern 3000 of stack 3 of FIG. 9 has the rotation angles that are all greater than 45° so as to be in the threshold angle range and thus the control unit 130 determines that the rotation pattern 3000 of stack 3 is valid. Otherwise, for the rotation pattern 4000 of stack 4 of which the pitch and roll angles are greater than 45° and the yaw angle is not greater than 45°, the control unit 130 determines that the rotation pattern 4000 of stack 4 is invalid.

According to an exemplary embodiment of the present invention, the terminal 100 determines whether the rotation pattern is valid for display mode switching in consideration of the yaw angle as well as the pitch and roll angles. Referring to the exemplary case 4 of FIG. 9, since although the pitch and roll angles are in the threshold angle range (55 and 60 degrees, respectively) the yaw angle is out of the threshold angle range, thus it is not the state requiring the display mode switching.

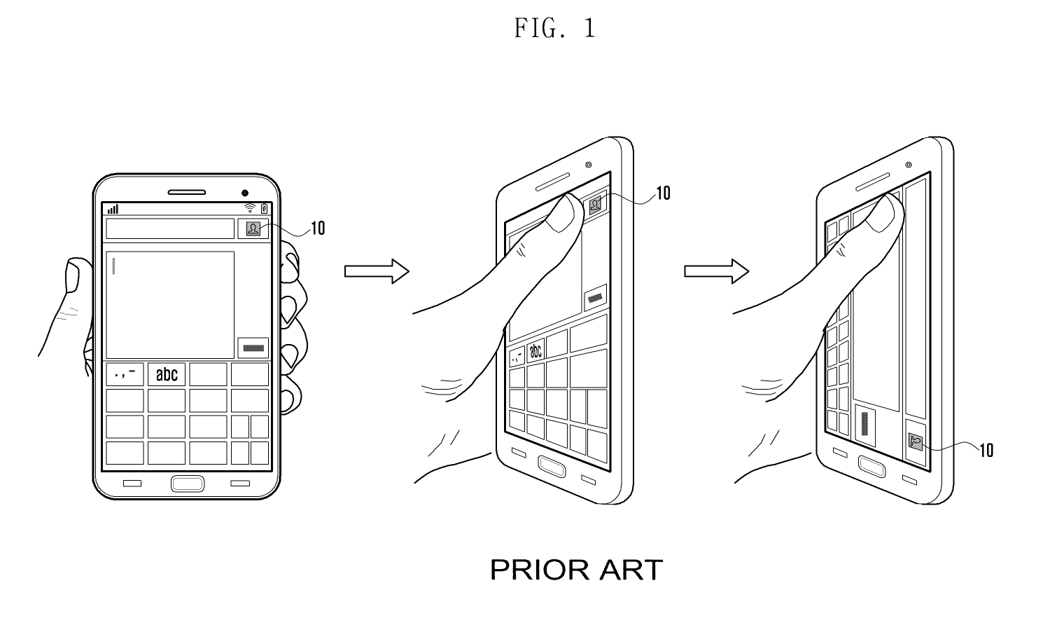

According to an exemplary embodiment of the present invention, the terminal 100 regards the rotation pattern as shown in FIG. 1 as an invalid rotation so as to do not switching between the display modes.

Referring again to the flowchart in FIG. 4, at S240 the control unit 130 determines based on the analysis result whether the extracted rotation pattern is a valid rotation pattern.

At S250, if the extracted rotation pattern is determined to be a valid rotation pattern based in for example, the previous description of S230 (and S231-234), the control unit 130 controls the display unit 150 to switch between the display modes at step 250.

The control unit 130 controls switching of the current display mode to the other display mode. For example, if the current display mode is the landscape mode, the control unit 130 controls the display unit 150 to switch from the landscape mode to the portrait mode.

The control unit 130 also can control the display orientation to rotate according to the extracted rotation pattern. For example, if the yaw angle is in the range of 30° ˜150° or −30° ˜−150°, the control unit 130 can switch display between the display modes. At this time, the control unit 130 determines whether to perform the display mode switching based on the current display mode. For example, if the extracted rotation pattern is the valid rotation pattern and if the yaw angle is in the range of 30° ˜150°, the appropriate display mode for this rotation pattern may comprise, for example, be the landscape mode. If the current display mode is the landscape mode, the control unit 130 does not power the display mode switching to maintain the landscape mode.

The control unit 130 can control the display mode switching to be performed with various visual effects. For example, the control unit 130 controls such that the display mode switching is performed with an animation effect such as moving, sliding, rotating, and swiping effects.

If the extracted rotation pattern is an invalid pattern, the control unit 130 can controls such that the current display mode is maintained. The control unit 130 also can extract the rotation pattern at the predetermined period to determine repeatedly whether the display mode switching is necessary.

According to an exemplary embodiment of the present invention, since the terminal 100 analyzes the rotation pattern and performs display mode switching only for the valid rotation pattern, it is possible to reduce unnecessary display mode switching, resulting in improvement of user convenience and usability.

Table 1 shows the display mode switching conditions based on the rotation pattern detected in use of the terminal 100 according to an embodiment of the present invention. In table 2, the yaw threshold angle is the value having an error range around 90°.

TABLE 1

| | | | | Display |
|---|---|---|---|---|
| | | | | mode |
| Pitch Θ | Roll φ | Yaw ψ | Terminal Condition | switching |
| 0 | 0 | 0 | Place on desk | No |
| 0 | 40 | 0 | Pick terminal up at left side by | No |
| | | | left hand | |
| 60 | 0 | 0 | Level eyes at screen as sat | No |
| 10 | 0 | 0 | Place on the palm | No |
| 10 | 50 | 0 | Tilted to push button at | No |
| | | | opposite side | |
| 60 | 0 | 0 | Level eyes at screen as sat | No |
| 60 | −50 | 90 | Rotated terminal to be long in | Yes |
| | | | horizontal direction | |
| −40 | −20 | 90 | Tilt in landscape mode state | No |
| . . . | . . . | . . . | . . . | . . . |
| 30 | 180 | 180 | Lay down looking up screen | No |
| 0 | 100 | 180 | Roll over to left | No |
| 0 | 120 | 90 | Rotate screen orientation to | Yes |
| | | | operate in landscape mode in | |
| | | | lie-down state | |
| −80 | 0 | 90 | Roll over to left in landscape | No |
| | | | mode state | |

As described above, the display mode switching control method and apparatus of a terminal according to the present invention determines whether to switch between display modes based on the tilted extent and/or gravity direction so as to avoid unnecessary display mode switching.

Also, the display mode switching control method and apparatus of the present invention determines whether to perform display mode switching based on the rotation pattern of the terminal so as to prevent the terminal from switching between the display modes unintentionally, resulting in improvement of user convenience.

The above-described methods according to the present invention can be implemented in hardware, firmware or as software or computer code that is stored in a recording medium such as a CD ROM, flash, EPROM, EEPROM, RAM, a floppy disk, thumbnail drive, a hard disk, or a magneto-optical disk or computer code downloaded over a network originally stored on a remote recording medium and then stored on a non-transitory medium and loaded into hardware such as a processor or microprocessor. The machine executable code stored on the non-transitory machine readable medium can be stored on a local recording medium, and loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitutes hardware in the claimed invention. Finally, the claimed invention can include the use of a location information server comprising more than one server, such as a proxy server.

It should be recognized to those skilled in the art that various modifications and changes can be made without departing from the concept of this invention. For example, it is within the spirit and scope of the presently claimed invention that although a valid rotation pattern determination is made based on three items (pitch, roll, yaw), there could be fewer items (two items rather than three), although three items is considered a preferable operation of the invention. In addition, although the examples herein all show the pitch, roll, and yaw angles being equal, the claimed invention is broader, and, for example, could be set at different thresholds (e.g., 40, 45 and 50 degrees). Also, the person of ordinary skill in the art should understand and appreciate that the threshold angle is a specified default, the claimed invention is broader and includes is user-changeable according to preference. In other words, in addition to merely enabling or disabling the automatic switching display mode, a user can go into a settings menu and change the value of the threshold angle to another value to increase or decrease the sensitivity of the switching threshold.

Although exemplary embodiments of the present invention have been described in detail hereinabove with specific terminology, this specification is provided for the purpose of describing particular embodiments only and not intended to be limiting of the invention. The scope of present invention should be construed to include everything within the scope of the appended claims and equivalents thereof.

What is claimed is:

1. A display mode switching control method of a portable terminal, comprising:
extracting by a control unit a rotation pattern including at least one of pitch, roll, and yaw angles of the portable terminal;
determining by the control unit whether or not the rotation pattern is a valid rotation pattern based on a threshold value of at least two angles; and
switching, when the rotation pattern is the valid rotation pattern, from a current display mode to another display mode.

2. The display mode switching control method according to claim 1, wherein the determining of whether or not the rotation pattern is a valid rotation pattern is based on the threshold value of all three of the pitch, roll, and yaw angles of the portable terminal.

3. The display mode switching control method of claim 2, wherein extracting comprises:
checking whether an automatic display mode switching function is enabled; and
extracting, when the automatic display mode switching function is enabled, the rotation pattern.

4. The display mode switching control method of claim 1, wherein extracting comprises checking the rotation pattern at a predetermined period.

5. The display mode switching control method of claim 2, wherein determining comprises:
comparing each of the angles with a predetermined threshold angle; and
judging, when all of the angles are in a predetermined threshold angle range defined by the threshold angle, that the rotation pattern is the valid rotation pattern.

6. The display mode switching control method of claim 2, wherein determining comprises:
comparing each of the pitch, roll, and yaw angles with a respective predetermined threshold angle;
judging, when all of the angles are in a respective predetermined threshold angle range defined by the respective predetermined threshold angle, that the rotation pattern is the valid rotation pattern.

7. The display mode switching control method of claim 1, wherein determining comprises:
determining whether the yaw angle is in a predetermined threshold angle range; and
judging, when the yaw angle is in the predetermined threshold angle range, that the rotation pattern is the valid rotation pattern.

8. The display mode switching control method of claim 1, wherein switching comprises:
determining a target display mode based on the rotation pattern; and
switching, when the target display mode differs from the current display mode, from the current display mode to the target display mode.

9. The display switching control method of claim 1, wherein threshold angle for each of the pitch, roll and yaw angles is a user-changeable value.

10. A portable terminal comprising:
a sensing unit which extracts a rotation pattern including one or more of a pitch, a roll, and a yaw angles;
a display unit which displays a screen; and
a control unit which determines whether the rotation pattern is a valid rotation pattern based on at least one or more of the pitch, roll, and yaw angles and controls, when the rotation pattern is the valid rotation pattern, the display unit to switch from a current display mode to other display mode.

11. The portable terminal of claim 10, wherein the control unit determines whether the rotation pattern is a valid rotation pattern based on at least two of the pitch, roll, and yaw angles.

12. The portable terminal of claim 10, wherein the control unit determines whether the rotation pattern is a valid rotation pattern based on all of the pitch, roll, and yaw angles.

13. The portable terminal of claim 10, wherein the control unit checks whether an automatic display mode switching function is enabled and controls, when the automatic display mode switching function is enabled, the sensing unit to extract the rotation pattern.

14. The portable terminal of claim 10, wherein the sensing unit senses the rotation pattern at a predetermined period.

15. The portable terminal of claim 12, wherein the control unit compares each of the pitch, roll and yaw angles with a predetermined threshold angle and judges, when all of the angles are in a threshold angle range defined by the threshold angle, that the rotation pattern is the valid rotation pattern.

16. The portable terminal of claim 10, wherein the control unit determines whether the yaw angle is in a predetermined threshold angle range and judges, when the yaw angle is in the threshold angle range, that the rotation pattern is the valid rotation pattern.

17. The portable terminal of claim 10, wherein the control unit determines a target display mode based on the rotation pattern and switches, when the target display mode differs from the current display mode, from the current display mode to the target display mode.

18. The portable terminal of claim 15, wherein the predetermined threshold angle comprises a respectively different value for at least one of the pitch, roll and yaw angles.

19. The portable terminal of claim 15, wherein the predetermined threshold angle is a user-changeable value.

20. The portable terminal of claim 18, wherein the predetermined threshold angle for each of the pitch, roll and yaw angles is a user-changeable value.
